(19) United States
(12) Patent Application Publication
(10) Pub. No.: US 2003/0225679 A1
(43) Pub. Date: Dec. 4, 2003

(54) Determining a distribution of a group purchase among a number of sellers that substantially minimizes an overall price of the group purchase

(75) Inventor: Manoel Tenorio, Brasilia (BR)

Correspondence Address: BAKER BOTTS L.L.P., 2001 ROSS AVENUE, SUITE 600, DALLAS, TX, 75201-2980, US

(73) Assignee: i2 Technologies US, Inc.

(21) Appl. No.: 10/430,472

(22) Filed: May 6, 2003

Related U.S. Application Data
(60) Provisional application No. 60/381,460, filed on May 16, 2002.

(51) Int. Cl. G06F 17/60

(52) U.S. Cl. 705/37

(57) ABSTRACT

In one embodiment of the present invention, a method for determining a distribution of a group purchase among a number of sellers that substantially minimizes an overall price of the group purchase includes generating a first set of distributions of the group purchase and, for each distribution in the first set, calculating a resulting overall price of the group purchase. One or more distributions are selected from the first set according to the resulting overall prices calculated for the distributions in the first set. One or more subsequent sets of distributions of the group purchase are generated, each subsequent set being generated from one or more solutions selected from an immediately preceding set of solutions according to resulting overall prices calculated for distributions in the immediately preceding set of solutions, the first subsequent set of distributions being generated from the distributions selected from the first set. A distribution resulting in a lowest overall price is selected from a final set of distributions, the distribution selected from the final set of distributions substantially minimizing the overall price of the group purchase.

### TECHNICAL FIELD OF THE INVENTION

This invention relates generally to electronic commerce and more particularly to determining a distribution of a group purchase among a number of sellers that substantially minimizes an overall price of the group purchase.

### BACKGROUND OF THE INVENTION

In an unbalanced market, there may be fewer market participants on one side of the market than the other, and those market participants may each have a capacity to buy or sell that is substantially greater than the capacity of any individual market participants on the other side of the market to sell or buy, respectively. In such a market, the larger-capacity market participants on the less populous side of the market may have substantially greater control over market prices, substantially greater bargaining power, and other advantages over the smaller-capacity market participants on the more populous side of the market. To lessen the effects of these and other possible market disadvantages, two or more smaller-capacity market participants may combine their market capacities and participate in the market as a single market entity, which may give them a more advantageous market presence.

While there may be benefits to such group buying or group selling, there may also be one or more drawbacks. For example, it may be difficult to allocate bought items among a group of buyers in a manner that substantially rewards individual members for their respective contributions to the market capacity of the group without substantially penalizing buyers for not making substantially large contributions to the market capacity of the group. It may also be difficult to achieve a satisfactory allocation of items among a group of buyers where the bought items differ from each other in one or more ways and the buyers each have different preferences pertaining to the bought items. It may also be difficult to determine what quantities of what items to buy from what sellers to substantially minimize an overall price paid by a group of buyers while substantially meeting the buying needs of the group of buyers. This may be especially difficult where one or more prices charged by one or more sellers for one or more items are noncausal.

### SUMMARY OF THE INVENTION

According to the present invention, disadvantages and problems associated with previous group buying techniques may be substantially reduced or eliminated.

In one embodiment of the present invention, a method for determining a distribution of a group purchase among a number of sellers that substantially minimizes an overall price of the group purchase includes generating a first set of distributions of the group purchase and, for each distribution in the first set, calculating a resulting overall price of the group purchase. One or more distributions are selected from the first set according to the resulting overall prices calculated for the distributions in the first set. One or more subsequent sets of distributions of the group purchase are generated, each subsequent set being generated from one or more solutions selected from an immediately preceding set of solutions according to resulting overall prices calculated for distributions in the immediately preceding set of solutions, the first subsequent set of distributions being generated from the distributions selected from the first set. A distribution resulting in a lowest overall price is selected from a final set of distributions, the distribution selected from the final set of distributions substantially minimizing the overall price of the group purchase.

Particular embodiments of the present invention may provide one or more technical advantages. For example, particular embodiments may provide a substantially fair allocation of bought items among a heterogeneous group of buyers. Particular embodiments may also provide an allocation of bought items among a group of buyers that takes into account a variety of pricing, preference, and other buyer constraints. Particular embodiments may also allow items to be allocated among a heterogeneous group of buyers in a way that substantially achieves peer equality within the group where the bought items are also heterogeneous. Particular embodiments may produce a substantially fair allocation where the pricing of bought items is causal (meaning quantity-independent). Particular embodiments may produce an allocation of bought items that substantially rewards individual members for their respective contribution to the market capacity of the group without substantially penalizing buyers unable to make substantially large contributions to the market capacity of group. Particular embodiments may determine what quantities of what items to buy from what sellers to substantially minimize an overall price paid by a group of buyers while substantially meeting the buying needs of the group. In particular embodiments, such a determination may be made where one or more prices charged by one or more sellers for one or more items are noncausal.

Certain embodiments may provide all, some, or none of these technical advantages, and certain embodiments may provide one or more other technical advantages which may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description, taken in conjunction with the accompanying drawings, in which:

FIG. 1 illustrates an example system supporting group buying;

FIG. 2 illustrates an example buying group;

FIG. 3 illustrates an example plot of items along two example axes;

FIG. 4 illustrates an example method for allocating items among buyers within a buying group; and

FIG. 5 illustrates an example method for determining a distribution of a group purchase among a number of sellers that substantially minimizes an overall price of the group purchase.

### DETAILED DESCRIPTION OF EXAMPLE EMBODIMENTS

FIG. 1 illustrates an example system 10 supporting group buying. System 10 may include one or more buyers 12, one or more sellers 14, and an electronic marketplace 16 associated with a website or other environment accessible to buyers 12 and sellers 14. In general, electronic marketplace 16 may receive offers to buy from buyers 12 and offers to sell from sellers 14 and match an appropriate offer to buy with an appropriate offer to sell, initiating a transaction between the corresponding buyer 12 and seller 14. Although buyers 12 and sellers 14 are described as separate entities, a buyer 12 in one transaction may be a seller 14 in another transaction, and vice versa. Moreover, reference to “buyer” or “seller” may include a person, a computer system, an enterprise, or any other buying or selling entity, as appropriate. For example, buyer 12 may include a computer programmed to autonomously identify a need for an item, search for that item, and buy that item upon identifying a suitable seller 14. Reference to “items” may include raw materials, component parts, products, or other tangible or intangible things that may be the subject of a transaction between buyer 12 and seller 14. Additionally, “items” may include lots, blocks, bundles, bushels, or other suitable units of one or more individual items, where appropriate. For example, capacitors may be bought and sold in indivisible units of 500 capacitors, instead of one capacitor at a time. Although buying and selling are primarily described herein, the present invention contemplates any appropriate market transaction.

Buyers 12, sellers 14, and electronic marketplace 16 may be coupled to each other using links 18 that may each include one or more local area networks (LANs), metropolitan area networks (MANs), wide area networks (WANs), a portion of the Internet, or any other appropriate wireline, optical, wireless, or other links. The components of electronic marketplace 16 may operate on one or more computers at one or more locations, and electronic marketplace 16 may share one or more computers or other resources with one or more buyers 12 or one or more sellers 14, according to particular needs. Offers to buy and offers to sell may be received by electronic marketplace 16 in any suitable format, such as in the form of Hypertext Markup Language (HTML), Extensible Markup Language (XML), or other suitable files within Hypertext Transport Protocol (HTTP) or other messages.

Associated with electronic marketplace 16, at one or more locations integral to or separate from electronic marketplace 16, may be one or more market servers 20, each supporting a particular electronic market for a particular item or class of items. For example, a particular market server 20 may receive offers to buy from buyers 12 and offers to sell from sellers 14, prioritize such offers, match appropriate offers to buy with appropriate offers to sell, initiate a transaction between a corresponding buyer 12 and seller 14 when a match has occurred between an offer to buy and an offer to sell, and perform other suitable tasks associated with supporting an electronic market.

Electronic markets supported by electronic marketplace 16 may be unbalanced. In an unbalanced market, as described above, the larger-capacity market participants on the less populous side of the market may have substantially greater control over market prices, substantially greater bargaining power, and other advantages over the smaller-capacity market participants on the more populous side of the market. To lessen the effects of these and other possible market disadvantages, two or more smaller-market participants may combine their market capacities and participate in the market as a single market entity, which may give them a more advantageous market presence and possibly provide other advantages.

For example, a particular electronic market supported by electronic marketplace 16 may include a relatively small number of larger-capacity sellers 14 and a relatively large number of smaller-capacity buyers 12. To compensate for their smaller market capacities and to reduce competition among them, two or more buyers 12c may combine their market capacities and participate in the market as a single market entity, example buying group 22. Each buyer 12c within buying group 22 may request a particular quantity of items and may be allocated from among the total quantity of items bought for buying group 22 a quantity of items that is substantially equal to the quantity requested by that buyer 12c. A group leader (which may be a member of buying group 22) or other representative of buying group 22 may buy items from one or more sellers 14 for buying group 22 according to some arrangement among buyers 12c. For example, the representative of buying group 22 may buy a quantity of items substantially equal to the sum of the quantities requested by buyers 12c at the lowest possible prices from one or more sellers 14. Additionally, certain restrictions may be placed on the representative of buying group 22. For example, the representative of buying group 22 may be instructed not to buy from certain sellers 14 or not to buy more than a pre-determined quantity of items from any one seller 14. The present invention contemplates any suitable restrictions on the representative of buying group 22 according to particular needs.

A buying group 22 making a group purchase (which may include one or more purchases of one or more items from one or more sellers 14) may want to substantially minimize an overall price of the group purchase, possibly subject to one or more restrictions. However, this may be difficult to do. One or more items may be available from a number of different sellers 14, and as a result it may be possible to distribute the group purchase among a number of different sellers 14 in a number of different ways. For example, a buying group 22 may want to purchase a first quantity of item A, a second quantity of item B, and a third quantity of item C. There may be a number of different sellers 14 that each sell item A, a number of different sellers 14 that each sell item B, a number of different sellers 14 that each sell item C, a number of different sellers 14 that each sell items A and B, a number of different sellers 14 that each sell items B and C, a number of different sellers 14 that each sell items A and C, and a number of different sellers 14 that each sell items A, B, and C. As a result, buying group 22 may purchase items A, B, and C from any of a number of different sellers 14 in any of a number of different combinations.

In addition, one or more prices of one or more items from one or more sellers 14 may be noncausal. A price of an item from a seller 14 may be noncausal if the price depends on one or more parameters of a group purchase, which parameters may include a quantity of the item bought from seller 14, quantities of one or more other items bought from seller 14, a total quantity of items bought from seller 14, a distribution of quantities of one or more items among buyers 12c within buying group 22, applicable regulations, transportation requirements associated with the item or one or more other items, and any other suitable parameter of the group purchase. For example, one or more of the sellers 14 described above selling item A may each provide buying group 22 one or more discounts based on a quantity of item A bought from seller 14. In addition or as an alternative to providing discounts based on a quantity of item A bought from seller 14, seller 14 may provide buying group 22 one or more discounts based on a quantity of item B or one or more other items bought from seller 14. Although particular examples of noncausal prices are described, the present invention contemplates any suitable noncausal prices of items available from sellers 14.

Thus, it may be difficult to determine a distribution of the group purchase among sellers 14 that substantially minimizes the overall price of the group purchase. There may be a large number of possible distributions, and calculating an overall price for each such distribution and subsequently comparing the calculated overall prices with each other may be extremely difficult or time consuming, requiring a very large number of calculations. To determine a distribution that substantially minimizes the overall price of the group purchase despite such difficulties, one or more genetic or similar algorithms may be used. A genetic algorithm may include an algorithm according to which solutions to a problem “evolve” over a series of “generations,” resulting in a solution that may be less than truly optimal but may be acceptable in light of the difficulty of finding a truly optimal solution. Any suitable computer system may use a genetic algorithm to determine a distribution that substantially minimizes the overall price. For example, a computer system associated with buying group 22, electronic marketplace 16, or both may use a genetic algorithm to determine such a distribution automatically or at the request of buying group 22 or another entity.

The term “solution” may, where appropriate, encompass a “genetic code” (which may include a string of bits or other values) representing a solution. Each solution may represent a particular distribution of the group purchase among sellers 14 and may include a number of elements. Each element of a solution may include one or more bits or other values and may include a different number of bits or other values than one or more other elements of the solution. Each element may correspond to an item from a seller 14, and a numerical value represented by the bits or other values of the element may represent a quantity of the corresponding item from the corresponding seller 14. Accordingly, each element may include as many bits as may be needed to accommodate a total quantity of a corresponding item that buying group 22 wants to buy. For example, the string “011001011110100101010000” may be a solution that includes six elements. A first element of the solution may be “0110,” a second element may be “0101,” a third element may be “1110,” a fourth element may be “1001,” a fifth element may be “0101” and a sixth element may be “0000.” The first element may correspond to a particular item from a particular seller 14 and the numerical value of the first element may represent a quantity of six of the particular item (since 0100₂ equals 6₁₀). Although an example solution is described, the present invention contemplates any suitable solution including any suitable number of elements that each include any suitable number of bits or other values.

According to a genetic algorithm, a first set of solutions to a problem may be generated (randomly or otherwise) and each solution in the set may be evaluated according to one or more specified objectives and possibly one or more constraints. A number of existing solutions may then be selected from the first set according to the evaluations and used to generate a second set of solutions. Each solution in the second set may then be evaluated according to the specified objectives and possibly the constraints. A number of existing solutions may then be selected from the second set according to the evaluations and used to generate a third set of solutions. This process may continue until a specified number of sets of solutions have been generated, until an acceptable solution is generated, or until no substantial improvement with respect to the specified objectives has occurred over a specified number of successive generations. Although a particular genetic algorithm has been described, the present invention contemplates any suitable genetic or similar algorithm. One advantage of genetic algorithms may be that they may maintain large numbers of parameters while at the same time providing random searches of particular dimensions.

One or more solutions may be generated from one or more existing solutions using any suitable technique. In particular embodiments, as an example and not by way of limitation, a crossover or similar technique may be used to generate two or more new solutions from two or more existing solutions. According to such a technique, one or more portions of one or more existing solutions may be “swapped” with one or more corresponding portions of one or more other existing solutions to generate one or more new solutions. For example, “0110110000” may be an existing “father” solution and “1001101001” may be an existing “mother” solution. Using a crossover technique, the last five bits of the father solution may be swapped with the last five bits of the mother solution to generate two new “child” solutions, “0110101001” and “1001110000.” In particular embodiments, as another example, an “asexual reproduction” or similar technique may be used to generate one or more solutions from an existing solution. According to one such technique, one or more existing solutions may be selected randomly or otherwise and carried over from one set of solutions to another set of solutions (which may include both new and previously existing solutions) unchanged. According to another such technique, one or more existing solutions may be selected randomly or otherwise and modified randomly or otherwise to generate one or more new solutions. Although particular techniques for generating solutions using existing solutions are described, the present invention contemplates any suitable techniques for generating solutions using existing solutions.

To determine a distribution of a group purchase among a number of sellers 14 that minimizes an overall price of the group purchase using one or more genetic algorithms, a first set of solutions may be generated. The first set of solutions may preferably include a large number of solutions, but may include any suitable number of solutions according to particular needs. As described above, each solution may represent a particular distribution of the group purchase among sellers 14 and may include a number of elements. Each element of a solution may include one or more bits or other values and may include a different number of bits or other values than one or more other elements of the solution. Each element may correspond to an item from a seller 14, and a numerical value represented by the bits or other values of the element may represent a quantity of the corresponding item from the corresponding seller 14. In particular embodiments, solutions in the first set may be generated by assigning to each element of each solution an arbitrary value from a substantially uniform distribution of possible values, which may result in solutions in the first set of solutions being substantially uniformly distributed.

After the first set of solutions has been generated, each existing solution in the first set may be evaluated. Evaluating a set of solutions may include calculating, for each solution in the set, an overall price of the group purchase according to the solution. In particular embodiments, evaluating the set of solutions may also include determining, for each solution in the set, whether the solution violates one or more restrictions on the group purchase. After each solution in the first set has been evaluated, a number of solutions may be selected from the first set according to one or more selection criteria. Any suitable selection criteria may be used. As an example and not by way of limitation, solutions in a set of solutions may be ranked (numerically or by percentile) according to resulting overall price and may be selected from the set of solutions according to rank. In addition or as an alternative, solutions resulting in overall prices below a specified cut-off price may be selected from the set of solutions. In particular embodiments, solutions that violate one or more restrictions on the group purchase may be barred from selection. Although particular selection criteria are described, the present invention contemplates any suitable criteria for selecting solutions from a set of solutions.

After a number of existing solutions have been selected from the first set, the selected solutions may be used to generate a second set of solutions, which may include any suitable number of solutions. As described above, any suitable technique may be used to generate solutions in the second set from the existing solutions selected from the first set. After the second set of solutions has been generated, each existing solution in the second set may be evaluated, a number of solutions may be selected from the second set, and the selected solutions may be used to generate a third set of solutions, as described above. This process may continue, in particular embodiments, until no substantial decrease in resulting overall price has occurred over a specified number of generations.

Whether a substantial decrease in resulting overall price has occurred may be determined according to a specified threshold. For example, a user may specify a threshold used to determine whether a substantial decrease in resulting overall price has occurred. Any suitable resulting overall price may be used to determine whether a substantial decrease in resulting overall price has occurred. As an example, an average resulting overall price for a set of solutions may be used. As another example, a best resulting overall price for a set of solutions may be used. A best resulting overall price for a set of solutions may in particular embodiments include a lowest overall price resulting from a solution in the set. After no substantial decrease in resulting overall price has occurred over a specified number of generations, a solution resulting in a lowest overall price and not violating one or more restrictions on the group purchase may be selected from a last generated set of solutions and used as a solution that substantially minimizes the overall price of the group purchase. If generated sets of solutions were stored, a solution resulting in a lowest overall price and not violating one or more restrictions on the group purchase may alternatively be selected from all sets of solutions that were generated and stored. This process may alternatively continue, in particular embodiments, until a specified number of sets of solutions have been generated, at which point a solution may be selected and used as a solution that substantially minimizes the overall price of the group purchase. This process may alternatively continue, in particular embodiments, until a solution that results in an acceptable overall price and does not violate one or more restrictions on the group purchase is generated. The solution resulting in the acceptable overall price may then be selected as a solution that substantially minimizes the overall price of the group purchase. Whether a solution results in an acceptable overall price may be determined according to a pre-specified overall price.

Items bought for buying group 22 may be heterogeneous. For example, items bought for buying group may differ from each other in terms of per-item price, associated delivery time, seller location, or other aspects. Additionally, buyers 12c within buying group 22 may be heterogeneous such that each buyer 12c may have different preferences pertaining to the items bought for buying group 22, which preferences may be stored as buyer preference information 24 in one or more databases accessible to allocation server 26, described more fully below. For example, one buyer 12c may prefer items having an associated delivery time between five and ten days, while another buyer 12c may prefer items having an associated delivery time between three and six days. There may also be universal preferences for buyers 12c within buying group. For example, each buyer 12c within buying group 22 may prefer less expensive items over more expensive items. Preferences for buyers 12c may include “must have” and “cannot have” preferences and may include complex preferences involving multiple parameters and multiple parameter values. For example, a preference for a particular buyer 12c may indicate that a delivery time of more than ten days for a particular item of items is acceptable only if the per-item price is below $5. Another preference for buyer 12c may indicate that a price of greater than $7 is acceptable only if the location of the seller is within Texas, Oklahoma, Arkansas, or Louisiana, but that a price over $8.50 is unacceptable regardless of the location of the seller. Moreover, preferences for buyer 12c may vary over the total quantity requested by buyer 12c. For example, a preference for buyer 12c may indicate that a delivery time of fifteen days is acceptable only if buyer 12c has already been allocated twenty items having an associated delivery time of five or fewer days. The present invention contemplates any suitable preferences for buyers 12c according to particular needs.

Due to the possible heterogeneity of the items bought for buying group 22, the possible heterogeneity of buyers 12c within buying group 22, and possibly other reasons, it may be difficult to achieve a satisfactory allocation of bought items among buyers 12c. Additionally, it may be difficult to achieve an allocation that substantially rewards individual buyers 12c for their respective contributions to the market capacity of buying group 22 without substantially penalizing buyers 12c for not making substantially large contributions to the market capacity of buying group 22. To facilitate the allocation of bought items among buyers 12c within buying group 22, electronic marketplace 16 may include one or more allocation servers 26 that may allocate items among buyers 12c according to a suitable algorithm. In one embodiment, for example, allocation server 26 may, as described more fully below, allocate items among buyers 12c by determining one or more “quantity leader” sets that each include one or more buyers 12c, prioritizing among the determined quantity leader sets, prioritizing among buyers 12c within each quantity leader set, and allocating bought items among buyers 12c according to the prioritization of the quantity leader sets, the prioritization of buyers 12c within each quantity leader set, and the preferences for each buyer 12c.

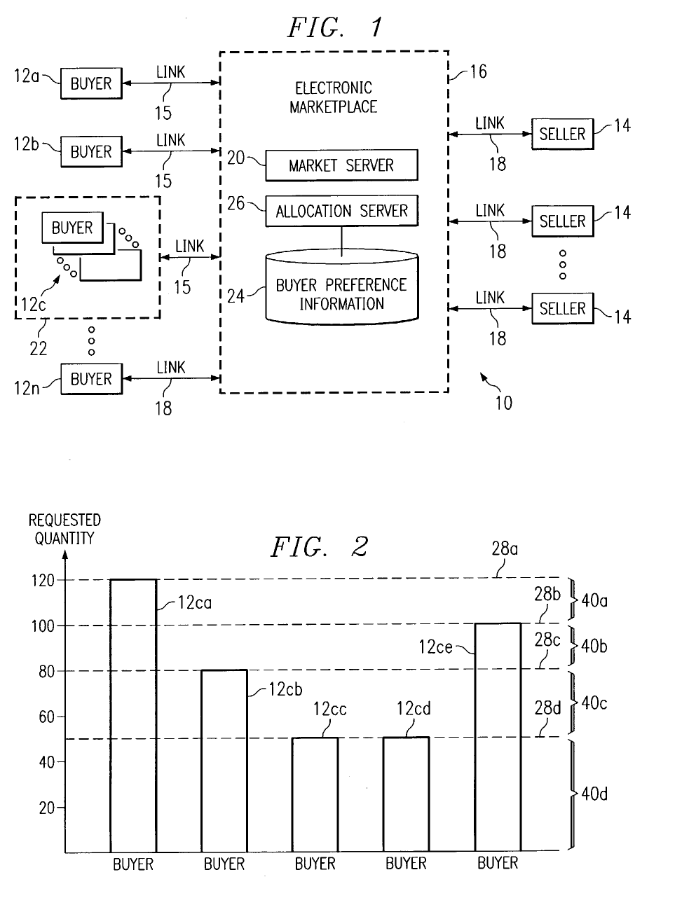

FIG. 2 illustrates example buying group 22. For example only and not by way of limitation, buying group 22 may include five buyers 12c, each having requested a particular quantity of items. As shown, buyer 12ca has requested one hundred twenty items, buyer 12cb has requested eighty items, buyers 12cc and 12cd have each requested fifty items, and buyer 12ce has requested one hundred items. Each quantity requested by one or more buyers 12c may define a quantity level. For example, the quantities requested by buyers 12c within buying group 22 may define quantity level 28a of one hundred twenty items, quantity level 28b of one hundred items, quantity level 28c of eighty items, and quantity level 28d of fifty items. As described above, allocation server 26 may determine one or more quantity leader sets. Each quantity leader set may be associated with two successive quantity levels 28 (meaning that no quantity level separates the two quantity levels 28) that together define a quantity range 40 and a quantity difference. Each quantity leader set may include one or more buyers 12c that have each requested a quantity of items that exceeds the lower of the two associated quantity levels 28, and a particular buyer 12c may be in more than one quantity leader set.

Within buying group 22, for example, a first quantity leader set may be associated with quantity levels 28a and 28b and may include buyer 12ca, quantity range 40a for the first quantity leader set may be one hundred to one hundred twenty items, and the quantity difference for the first quantity leader set may be twenty items. A second quantity leader set may be associated with quantity levels 28b and 28c and may include buyers 12ca and 12ce, quantity range 40b for the second quantity leader set may be eighty to one hundred items, and the quantity difference for the second quantity leader set may be twenty items. A third quantity leader set may be associated with quantity levels 28c and 28d and may include buyers 12ca, 12cb, and 12ce, quantity range 40c for the third quantity leader set may be fifty to eighty items, and the quantity difference for the third quantity leader set may be thirty items. A fourth quantity leader set may be associated with quantity level 28d and a base quantity level (which may be zero items) and may include buyers 12ca, 12cb, 12cc, 12cd, and 12ce, quantity range 40d for the fourth quantity leader set may be zero to fifty items, and the quantity difference for the first quantity leader set may be fifty items.

Allocation server 26 may prioritize among quantity leader sets, as briefly described above. In one embodiment, a quantity leader set associated with a higher quantity range 40 may be given a higher priority than a quantity leader set associated with a lower quantity range 40. Among the example quantity leader sets described above, for example, the first quantity leader set may be given first priority, the second quantity leader set may be given second priority, the third quantity leader set may be give third priority, and the fourth quantity leader set may be given fourth priority. Additionally, allocation server 26 may prioritize among buyers 12c within each quantity leader set. In one embodiment, buyer 12c that has requested a larger quantity of items may be given a higher priority than buyer 12c that has requested a smaller quantity of items. For example, in each example quantity leader set described above in which the following buyers 12c are included, buyer 12ca may be given first priority, buyer 12ce may be given second priority, buyer 12cb may be given third priority, and buyers 12cc and 12cd may be each be given fourth priority (alternatively, allocation server 26 may prioritize among buyers 12c that have requested substantially equal quantities using a suitable “tie-breaking” technique).

As described above, allocation server 26 may allocate bought items among buyers 12c within buying group 22 according to the prioritization of the determined quantity leader sets and the prioritization of the buyers 12c within each quantity leader set. In one embodiment, a pre-determined quantity of items may be allocated to each buyer 12c within a quantity leader set associated with a higher quantity range 40 before a pre-determined quantity of items may be allocated to each buyer 12c within a quantity leader set associated with a lower quantity range 40. The predetermined quantity of items allocated to each buyer 12c within a quantity leader set may be substantially equal to the quantity difference for the quantity leader set. Within a quantity leader set, items may be allocated among buyers 12c within the quantity leader set in a series of rounds in which a higher-priority buyer 12c may be allocated a quantity of items that is less than the quantity difference for the quantity leader set before a lower-priority buyer 12c may be allocated the same quantity of items. Each such round may continue until each buyer 12c within the quantity leader set has been allocated the quantity of items, and the series of rounds may continue until each buyer 12c within the quantity leader set has been allocated the predetermined quantity of items substantially equal to the quantity difference for the quantity leader set.

For example, items bought for buying group 22 may be distributed among buyers 12c as follows. Allocation server 26 may begin with the first quantity leader set and allocate twenty items to buyer 12ca (buyer 12ca is the only buyer 12c within the first quantity leader set). Allocation server 26 may then proceed to the second quantity leader set and allocate, in the following order, one item to buyer 12ca, one item to buyer 12ce, one item to buyer 12ca, one item to 12ce, and so on, until buyers 12ca and 12ce have each been allocated twenty items. Allocation server 26 may then proceed to the third quantity leader set and allocate, in the following order, one item to buyer 12ca, one item to buyer 12ce, one item to buyer 12cb, one item to buyer 12ca, one item to buyer 12ce, one item to buyer 12cb, and so on, until buyers 12ca, 12ce, and 12cb have each been allocated thirty items. Allocation server 26 may then proceed to the fourth quantity leader set and allocate, in the following order, one item to buyer 12ca, one item to buyer 12ce, one item to buyer 12cb, one item to buyer 12cc, one item to buyer 12cd, one item to buyer 12ca, one item to buyer 12ce, one item to buyer 12cb, one item to buyer 12cc, one item to buyer 12cd, and so on, until buyers 12ca, 12ce, 12cb, 12cc and 12cd have each been allocated fifty items. (As described above, the order in which buyers 12cc and 12cd are allocated items may be determined using a suitable tie-breaking technique. Alternatively or in addition, the order in which buyers 12cc and 12cd are allocated items may alternate from round to round.) In this way, each buyer 12c within buying group may be allocated a quantity of items substantially equal to their respective requested quantities.

When allocating one or more items to a particular buyer 12c, allocation server 26 may locate among the available items (meaning those items that have not yet been allocated to a particular buyer 12c) the one or more items providing a substantial match with one or more preferences for buyer 12c, which match may be the best match possible among the available units. Allocation server 26 may use any suitable matching technique to locate items providing a substantial match with one or more preferences for buyer 12c.

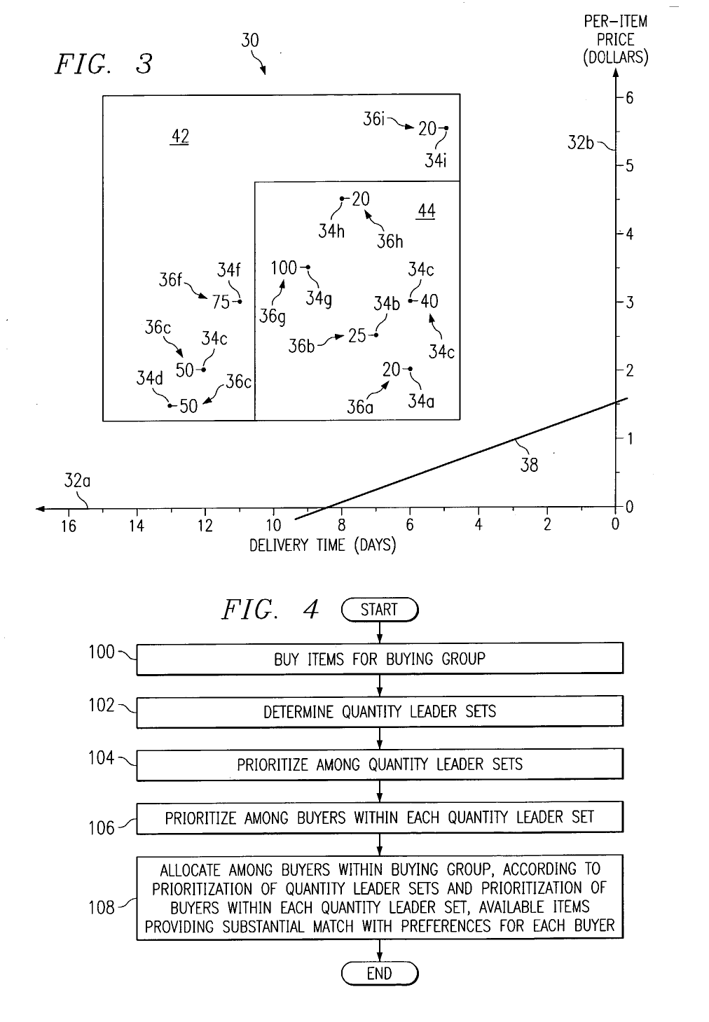

FIG. 3 illustrates an example plot 30 of items along two example axes 32. Allocation server 26 may generate example plot 30 to match available items with preferences for buyers 12c. Axes 32 may each represent a particular attribute of the items bought for group 22. For example, axis 32a may represent delivery time and axis 32b may represent per-item price. Although example plot 30 includes two particular axes 32, the present invention contemplates any suitable number of axes 32 representing any suitable attributes that may be associated with items bought for group 22. Points 34, each corresponding to an available quantity of items having a particular combination of attribute values (meaning specific instances of attributes associated with items bought for buying group 22) may be placed along axes 32 in accordance with their respective attribute values. For example, point 34a may correspond to available items costing $2 per item and having an associated delivery time of six days. Associated with each point 34 may be quantity indicator 36 indicating the available quantity of items having the combination of attribute values corresponding to that point 34. For example, quantity indicator 36a may indicate that there are twenty available items costing $2 per item and having an associated delivery time of six days.

Allocation server 26 may also generate “hyperplane” 38, which may embody any suitable combination of preferences for buyer 12c. For example, the slope of hyperplane 38 may represent a preferential combination of per-item price and delivery time for buyer 12c. Additionally or as an alternative, hyperplane 38 may embody any suitable combination of preferences for buyer 12c by virtue of the shape, color, length, or other suitable aspect of hyperplane 38, such as gaps, holes, or contours included in hyperplane 38. Although example hyperplane 38 is described herein, the present invention contemplates any suitable hyperplane embodying any suitable combination of preferences for buyer 12c in any suitable way. In addition or as an alternative to hyperplane 38, one or more preferences for buyer 12c may be represented by a suitable combination of one or more areas of inclusion 44 and one or more areas of exclusion 42. Areas of inclusion 44 may correspond to one or more ranges of attribute values acceptable to buyer 12c, and items corresponding to points 34 within areas of inclusion 44 may be allocated to buyer 12c. In contrast, areas of exclusion 42 may correspond to one or more ranges of attribute values unacceptable to buyer 12c, and items corresponding to points 34 within areas of exclusion 42 may not be allocated to buyer 12c. Areas of inclusion 44 and areas of exclusion 42 may also be used to represent “must have” and “cannot have” preferences, respectively, for buyer 12c. To locate among the available items bought for buying group 22 a substantial match with one or more preferences for a particular buyer 12c, allocation server 26 may move hyperplane 38 through plot 30 in a suitable manner until hyperplane 38 encounters a suitable point 34. Upon encountering a suitable point 34, allocation server 26 may allocate to buyer 12c a suitable quantity of items corresponding to point 34 and adjust the corresponding quantity indicator 36 accordingly.

Although plot 30, hyperplane 38, and the moving of hyperplane 38 through plot 30 have been described, the present invention contemplates a substantial match with one or more preferences for a particular buyer 12c being located among available items bought for buying group 22 using any suitable technique. For example, such a match may be located entirely within data, without generating plot 30 or hyperplane 38 or otherwise graphically representing items or buyer preferences or moving hyperplane 38 through plot 30.

FIG. 4 illustrates an example method for allocating items among buyers 12c within buying group 22. The method begins at step 100, where items are bought for buying group 22. At step 102, allocation server 26 determines one or more quantity leader sets for buying group 22. Although allocation server 26 is particularly described as performing certain tasks associating with allocating items among buyers 12c within buying group 22, the present invention contemplates any suitable combination of devices internally or externally associated with electronic marketplace 16 performing such tasks. Allocation server 26 prioritizes among the determined quantity leader sets at step 104 and, at step 106, prioritizes among buyers within each quantity leader set. At step 108, allocation server allocates among buyers 12c within buying group 22, according to the prioritization of the determined quantity leader sets and the prioritization of buyers 12c within each determined quantity leader set, available units of items providing a suitable match with one or more preferences for each buyer within buying group 22, and the method ends.

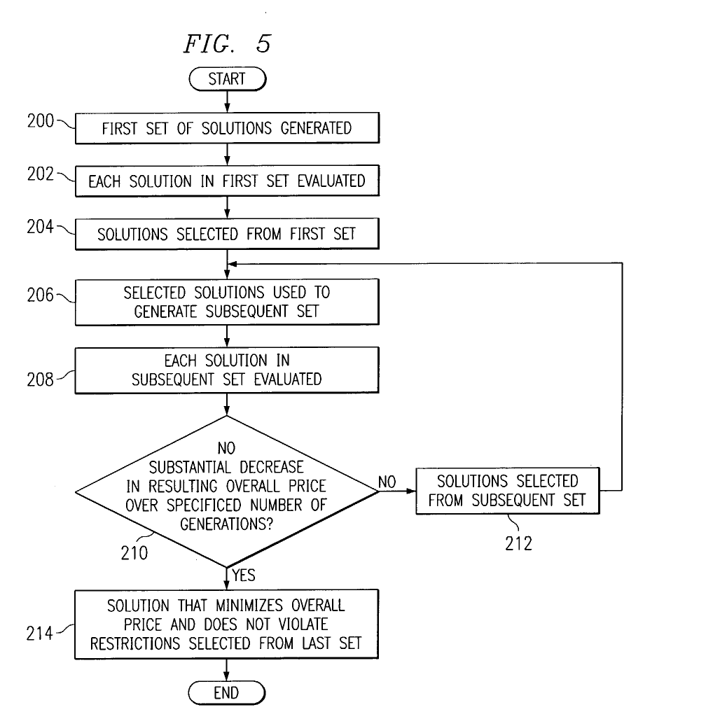

FIG. 5 illustrates an example method for determining a distribution of a group purchase among a number of sellers 14 that substantially minimizes an overall price of the group purchase. The method begins at step 200, where a first set of solutions is generated. As described above, any suitable computer system may determine a distribution that substantially minimizes the overall price. For example, a computer system associated with buying group 22, electronic marketplace 16, or both may determine such a distribution. As described above, each solution may represent a particular distribution of the group purchase among sellers 14 and may include a number of elements. Each element may correspond to an item from a seller 14 and may include as many bits as may be needed to accommodate a total quantity of the item that buying group 22 wants to buy. A numerical value of an element may represent a quantity of a corresponding item from a corresponding seller 14. The first set of solutions may preferably include a large number of solutions, but may include any suitable number of solutions according to particular needs. In particular embodiments, as described above, solutions in the first set may be generated by assigning to each element of each solution an arbitrary value from a uniform distribution of possible values, which may result in solutions in the first set of solutions being uniformly distributed.

At step 202, each existing solution in the first set is evaluated. As described above, evaluating a set of solutions may include, for each solution in the set, calculating an overall price of the group purchase according to the solution and determining whether the solution violates one or more restrictions on the group purchase. At step 204, a number of solutions are selected from the first set according to one or more selection criteria. As described above, any suitable selection criteria may be used. At step 206, the selected solutions are used to generate a subsequent set of solutions. As described above, any suitable technique may be used to generate solutions in one set from solutions in another set. At step 208, each solution in the subsequent set is evaluated, as described above. At step 210, if a substantial decrease in resulting overall price has occurred over a specified number of generations or if the specified number of generations has not yet been generated, the method proceeds to step 212. At step 212, a number of solutions are selected from the subsequent set according to one or more selection criteria, and the method returns to step 206 for generation of a subsequent set of solutions. At step 210, if no substantial decrease in resulting overall price has occurred over the specified number of generations, the method proceeds to step 214. As described above, an average resulting overall price for a set of solutions or a best resulting overall price for a set of solutions may be used to determine whether a substantial decrease in resulting overall price has occurred. At step 214, a solution resulting in a lowest overall price and not violating one or more restrictions on the group purchase is selected from a last set of solutions, at which point the method ends. The solution selected from the last set of solutions may be used as a solution that substantially minimizes the overall price of the group purchase.

Although the present invention has been described with several embodiments, sundry changes, substitutions, variations, alterations, and modifications may be suggested to one skilled in the art, and it is intended that the invention may encompass all such changes, substitutions, variations, alterations, and modifications falling within the spirit and scope of the appended claims.

What is claimed is:

1. A system for determining a distribution of a group purchase among a number of sellers that substantially minimizes an overall price of the group purchase, the system comprising one or more components collectively operable to:
generate a first set of distributions of the group purchase;
for each distribution in the first set, calculate a resulting overall price of the group purchase;
according to the resulting overall prices calculated for the distributions in the first set, select one or more distributions from the first set;
generate one or more subsequent sets of distributions of the group purchase, each subsequent set being generated from one or more solutions selected from an immediately preceding set of solutions according to resulting overall prices calculated for distributions in the immediately preceding set of solutions, the first subsequent set of distributions being generated from the distributions selected from the first set; and
from a final set of distributions, select a distribution resulting in a lowest overall price, the distribution selected from the final set of distributions substantially minimizing the overall price of the group purchase.

2. The system of claim 1, wherein a distribution is represented by a string of bits that comprises a plurality of elements, each element corresponding to an item from a seller and comprising one or more bits, a value of an element representing a quantity of a corresponding item from a corresponding seller.

3. The system of claim 2, wherein the distributions in the first set are generated by assigning to each element of each distribution in the first set an arbitrary value from a substantially uniform distribution of possible values.

4. The system of claim 1, wherein sets of distributions are generated according to genetic algorithms and a subsequent set of distributions is generated from an immediately preceding set of distributions using one or both of a crossover technique and an asexual reproduction technique.

5. The system of claim 1, wherein the subsequent sets are generated until a resulting overall price has remained substantially constant over a specified number of generations.

6. The system of claim 5, wherein the resulting overall price comprises an average resulting overall price.

7. The system of claim 1, wherein the subsequent sets are generated until an acceptable distribution of the group purchase has been generated.

8. The system of claim 1, wherein the subsequent sets are generated until a specified number of sets have been generated.

9. The system of claim 1, wherein the final set of distributions comprises all generated sets of distributions.

10. The system of claim 1, wherein the final set of distributions comprises a last generated set of distributions.

11. The system of claim 1, wherein there are one or more restrictions on the group purchase, a distribution that violates the one or more restrictions being barred from selection.

12. The system of claim 1, wherein the one or more components are software components executable by a computer system associated with a buying group making the group purchase.

13. The system of claim 1, wherein one or more prices of one or more items from one or more sellers are noncausal such that the prices of the items depend on one or more parameters of the group purchase.

14. The system of claim 1, wherein the group purchase is made according to the distribution selected from the final set of distributions.

15. A method for determining a distribution of a group purchase among a number of sellers that substantially minimizes an overall price of the group purchase, the method comprising:
generating a first set of distributions of the group purchase;
for each distribution in the first set, calculating a resulting overall price of the group purchase;
according to the resulting overall prices calculated for the distributions in the first set, selecting one or more distributions from the first set;
generating one or more subsequent sets of distributions of the group purchase, each subsequent set being generated from one or more solutions selected from an immediately preceding set of solutions according to resulting overall prices calculated for distributions in the immediately preceding set of solutions, the first subsequent set of distributions being generated from the distributions selected from the first set; and
from a final set of distributions, selecting a distribution resulting in a lowest overall price, the distribution selected from the final set of distributions substantially minimizing the overall price of the group purchase.

16. The method of claim 15, wherein a distribution is represented by a string of bits that comprises a plurality of elements, each element corresponding to an item from a seller and comprising one or more bits, a value of an element representing a quantity of a corresponding item from a corresponding seller.

17. The method of claim 15, wherein the distributions in the first set are generated by assigning to each element of each distribution in the first set an arbitrary value from a substantially uniform distribution of possible values.

18. The method of claim 15, wherein sets of distributions are generated according to genetic algorithms and a subsequent set of distributions is generated from an immediately preceding set of distributions using one or both of a crossover technique and an asexual reproduction technique.

19. The method of claim 15, wherein the subsequent sets are generated until a resulting overall price has remained substantially constant over a specified number of generations.

20. The method of claim 19, wherein the resulting overall price comprises an average resulting overall price.

21. The method of claim 15, wherein the subsequent sets are generated until an acceptable distribution of the group purchase has been generated.

22. The method of claim 15, wherein the subsequent sets are generated until a specified number of sets have been generated.

23 The method of claim 15, wherein the final set of distributions comprises all generated sets of distributions.

24. The method of claim 15, wherein the final set of distributions comprises a last generated set of distributions.

25. The method of claim 15, wherein there are one or more restrictions on the group purchase, a distribution that violates the one or more restrictions being barred from selection.

26. The method of claim 15, wherein one or more prices of one or more items from one or more sellers are noncausal such that the prices of the items depend on one or more parameters of the group purchase.

27. The method of claim 15, further comprising making the group purchase according to the distribution selected from the final set of distributions.

28. A system for determining a distribution of a group purchase among a number of sellers that substantially minimizes an overall price of the group purchase, the system comprising one or more software components executable by a computer system associated with a buying group making the group purchase, the software components collectively operable to:
generate, according to a genetic algorithm, a first set of distributions of the group purchase, a distribution being represented by a string of bits that comprises a plurality of elements, each element corresponding to an item from a seller and comprising one or more bits, a value of an element representing a quantity of a corresponding item from a corresponding seller, the distributions in the first set being generated by assigning to each element of each distribution in the first set an arbitrary value from a substantially uniform distribution of possible values;
for each distribution in the first set, calculate a resulting overall price of the group purchase;
according to the resulting overall prices calculated for the distributions in the first set, select one or more distributions from the first set;
until an acceptable distribution of the group purchase has been generated, generate one or more subsequent sets of distributions of the group purchase according to the genetic algorithm, each subsequent set being generated from one or more solutions selected from an immediately preceding set of solutions according to resulting overall prices calculated for distributions in the immediately preceding set of solutions, the first subsequent set of distributions being generated from the distributions selected from the first set; and
from a final set of distributions, select a distribution resulting in a lowest overall price, the distribution selected from the final set of distributions substantially minimizing the overall price of the group purchase.

29. A method for determining a distribution of a group purchase among a number of sellers that substantially minimizes an overall price of the group purchase, the system comprising one or more software components executable by a computer system associated with a buying group making the group purchase, the method comprising:
generating, according to a genetic algorithm, a first set of distributions of the group purchase, a distribution being represented by a string of bits that comprises a plurality of elements, each element corresponding to an item from a seller and comprising one or more bits, a value of an element representing a quantity of a corresponding item from a corresponding seller, the distributions in the first set being generated by assigning to each element of each distribution in the first set an arbitrary value from a substantially uniform distribution of possible values;
for each distribution in the first set, calculating a resulting overall price of the group purchase;
according to the resulting overall prices calculated for the distributions in the first set, selecting one or more distributions from the first set;
until an acceptable distribution of the group purchase has been generated, generating one or more subsequent sets of distributions of the group purchase according to the genetic algorithm, each subsequent set being generated from one or more solutions selected from an immediately preceding set of solutions according to resulting overall prices calculated for distributions in the immediately preceding set of solutions, the first subsequent set of distributions being generated from the distributions selected from the first set; and
from a final set of distributions, selecting a distribution resulting in a lowest overall price, the distribution selected from the final set of distributions substantially minimizing the overall price of the group purchase.
